(19) United States
(12) Patent Application Publication
(10) Pub. No.: US 2014/0375245 A1
(43) Pub. Date: Dec. 25, 2014

(54) Remote Control Charging Base With Extendable Wall

(71) Applicant: LaVerne Strawderman, Maysville, WV (US)

(72) Inventor: LaVerne Strawderman, Maysville, WV (US)

(21) Appl. No.: 14/194,865

(22) Filed: Mar. 3, 2014

Related U.S. Application Data
(60) Provisional application No. 61/838,713, filed on Jun. 24, 2013.

(51) Int. Cl. H02J 7/00; H02J 7/35

(52) U.S. Cl. CPC H02J 7/0044; H02J 7/35; H02J 7/0047
USPC 320/101

(57) ABSTRACT

The present invention provides a charging base that is adapted to provide power to a remote control. The charger comprises an upper surface, lengthwise side walls, and widthwise side walls. The upper surface comprises a contour that is adapted to receive the body of a remote control thereon. Energy is generated and transferred to the remote control by a pair of solar panels located along the lengthwise walls of the base. One of the widthwise walls includes a pair of buttons. The first button is configured to send a signal that is adapted to activate an alarm on the remote control, thereby notifying a user to the location of a lost remote. A second button is configured to project out a cup holder from the widthwise wall. Individuals can have a drink in the holder without worry of spilling liquids on the remote and causing damages on the remote control.

### CROSS REFERENCE TO RELATED APPLICATION

This application claims the benefit of U.S. Provisional Application No. 61/838,713 filed on Jun. 24, 2013, entitled “Rechargeable Universal Remote with Pager/Locator and Cup Holder. The above identified patent application is herein incorporated by reference in its entirety to provide continuity of disclosure.

### BACKGROUND OF THE INVENTION

1. Field of the Invention

The present invention relates to a remote control charging base. More specifically the invention relates to a remote control charging base that further comprises a cup holder that projects outward from the base.

Remote controls are frequently used to control a variety of electronic devices around a household. A single controller can operate a television, DVD, DVR, VCR, and stereo. The variety of operating abilities of the remote control has caused them to be a very important object in the household, and because of this the remote control goes through a large amount of batteries. Users often keep the remote control with them at all times, including when eating and drinking. Damage from food or spilled drinks can potentially ruin the remote.

Many people attempt to provide dedicated locations for placing their remotes when not in use. These places often include positions near the television or at the couch where they frequently sit. It is known however, that remotes are often misplaced, and when a user is accustomed to something in its normal place it is difficult finding the missing object when it is placed elsewhere. Moreover, when a high-functioning remote control is misplaced the batteries continuously drain until the remote has no remaining power. Additionally, users often have difficulty in providing a location for the placement of drinks. The leading solution is to use a tray, but this requires the placement of an extra furniture piece near the user.

There are known prior art devices that are configured to solve the downsides of misplacing a remote control. Some prior art devices provide a universal remote control that comprises a recharging means, whereby the recharging mean may comprise a charging base that is adapted to receive a remote control. Another prior art device provides an electronic pager that is adapted to notify a user as to the location of a missing object. These devices, however, fail to provide a location for the placement of a drink that is near a remote control station.

The present invention, however, provides a multifunctional universal remote control charging base. The base comprises an upper surface and first and second pairs of side walls. The upper surface is contoured to receive and charge the remote control. A pair of charging prongs on the upper surface are configured to align with the prongs of a remote control. The first pair of side walls comprises solar panels that are adapted to supply power to a batter which energizes a set of charging prongs, wherein the charging prongs supply power to the batteries of the remote control. One of the second set of side walls includes actuatable buttons. A first button is configured to send a signal to the remote control. The signal is configured to activate an audible alarm on the remote control, whereby the alarm is adapted to lead a user to the location of the missing remote control. The second button is designed to actuate a section of the side wall, thereby causing the side wall to project outward. The sidewall comprises a cylindrical cavity therein that is adapted to receive a user's cup. The present invention, therefore, provides a dedicated remote control receiving spot, a charging base, a remote control locator, and a suitable cup holder that is adapted to reduce the likelihood of spills.

2. Description of the Prior Art

Devices have been disclosed in the prior art that relate to remote control placement surfaces. These include devices that have been patented and published in patent application publications. These devices generally relate to wired remote control charging bases. The following is a list of devices deemed most relevant to the present disclosure, which are herein described for the purposes of highlighting and differentiating the unique aspects of the present invention, and further highlighting the drawbacks existing in the prior art.

One such prior art device, U.S. Pat. No. 6,879,254 to Graham provides a rechargeable universal remote control assembly. The assembly includes a base unit with an upper surface shaped to fit a remote control thereon. Additionally, the base includes a button that is configured to send a signal to the remote control. The signal then activates an audible alarm on the remote control that can aid a user in finding a lost remote control. The prior art of Graham, however, fails to further provide a solar panel on the charging base, whereby the solar panel is adapted to supply a recharging energy to the remote control.

Another prior art device, U.S. Pat. No. 6,489,746 to Pettinato provides a rechargeable remote control with a built in battery charger for recharging batteries in the remote control. The remote control further includes a plug for insertion into an outlet. Thereafter, the outlet supplies power to the remote through the plug, thereby supplying a charging power to the rechargeable batteries within the remote control. The device of Pettinato, however, fails to further provide a charging base that comprises a signal configured to activate an alarm on the remote control, thereby assisting a user to find a lost controller.

Yet another prior art device, U.S. Patent Publication No. 2008/0186410 to Hardacker, provides a charging base that charges a remote control when the remote is docked on the surface of the charging base. The charging base is configured to recharge a variety of peripheral devices. The charging base, however, fails to provide a signal configured to activate an alarm on the remote, and further fails to provide a base with a cup holder for the placement of beverages thereon.

U.S. Patent Publication No. 2012/0154118 to Liu provides an electronic pager that is configured to transmit searching signals. The pager comprises a button sends a signal to a receiving mechanism. The receiver comprises a buzzer that makes a sound when activated by the signal sent from the pager. A user can follow the sound to locate the misplaced object. The prior art device of Liu, however, fails to further provide a charging base that is adapted to recharge the battery of a remote control.

Finally, U.S. Design Pat. No. D672,320 to Love provides an ornamental design for a universal remote control with an associated charging base. The charging base is powered by an outlet that is configured to transmit energy for recharging a remote control. The base comprises a receiving cavity that is adapted to vertically receive the remote control for charging therein. The device, however, fails to provide a button configured for sending a signal for locating a lost remote control. Moreover, the base fails to provide solar powered panels.

The present invention, however, provides a charging base for recharging a remote control. The base comprises an upper surface, widthwise side walls, and lengthwise side walls. The upper surface comprises a contour that is adapted to receive the body of a remote control. Charging prongs on the upper surface of the base are configured to align with corresponding prongs on the underside of the remote control. The lengthwise side walls each comprise a solar panel that is configured to supply energy to the charging prongs thereby facilitating the transfer of energy from the base to the remote. The base further includes a pair of actuatable buttons. A first button is configured to transmit a signal to a receiver in the remote control. The receiver then activates an alarm in the remote that alerts a user to the location of a lost remote control. The second button is configured to push out a widthwise side wall. The wall comprises a cylindrical cavity that is adapted to receive a cup therein, thereby reducing the likelihood that a user would spill a drink on a remote control or elsewhere in a room.

It is submitted that the present invention is substantially divergent in design elements from the prior art and consequently it is clear that there is a need in the art for an improvement of remote control charging bases. In this regard the instant invention substantially fulfills these needs.

### SUMMARY OF THE INVENTION

In view of the foregoing disadvantages inherent in the known types of remote control charging bases now present in the prior art, the present invention provides a new charging base wherein the same can be utilized for providing convenience for the user when a user desires a way to locate a lost remote control, and further provides convenience when a user desires a location to place their drinks.

It is therefore an object of the present invention to provide a new and improved remote control charging base that has all of the advantages of the prior art and none of the disadvantages.

It is another object of the present invention to provide a remote control charging base that comprises an energy storage means and energy generation means in the form of a battery and solar cells, respectively.

Another object of the present invention is to provide a remote control charging base that comprises a paging button that is adapted to assist a user in finding a lost remote control.

Yet another object of the present invention is to provide a remote control charging base with a cup holder for supporting a beverage therein.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 displays a view of the solar-powered cradle and remote of the present invention.

FIG. 2 displays an internal view of the solar-powered remote control charging base and remote control of the present invention.

FIG. 3 displays a view of the solar-powered cradle in use, whereby a remote control is positioned on the upper surface of the cradle.

FIG. 4 displays a view of the solar-powered cradle in use, whereby the actuatable button alerts a user to the location of the remote.

FIG. 5 displays a view of the solar-powered cradle in use, whereby a cup holder is deployed from the charging base.

### DETAILED DESCRIPTION OF THE INVENTION

Reference is made herein to the attached drawings. Like reference numerals are used throughout the drawings to depict like or similar elements of the solar powered charging base. For the purposes of presenting a brief and clear description of the present invention, the preferred embodiment will be discussed as used for charging a remote control, and further for providing a charging base with an incorporated cup holder. The figures are intended for representative purposes only and should not be considered to be limiting in any respect.

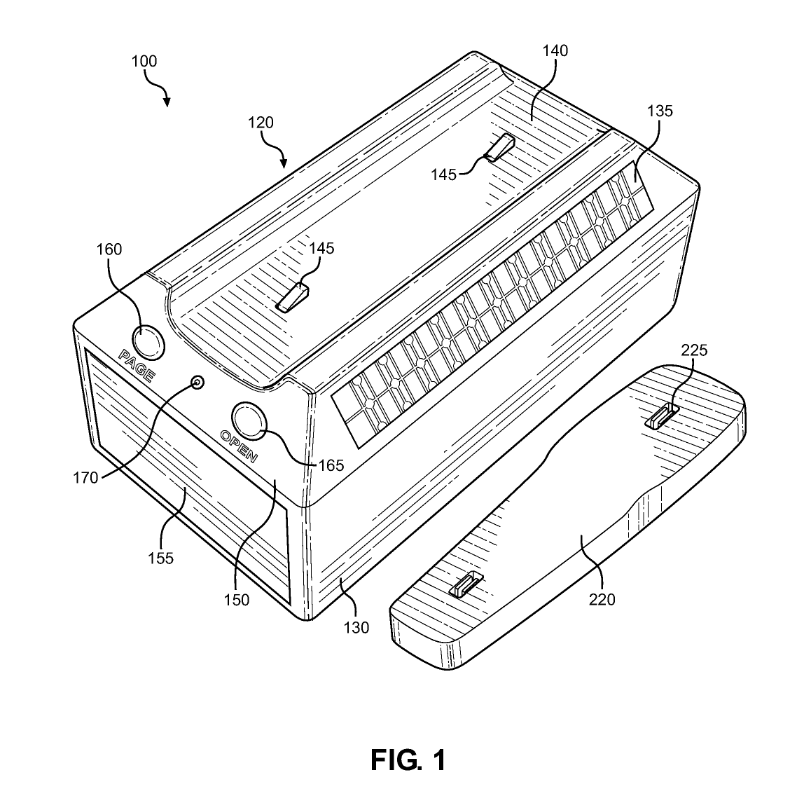

Referring now to FIG. 1, there is shown a view of the remote control charging base 100 and remote control 220 of the present invention. The charging base 100 comprises an upper surface 120 and a first set of side walls 130 that are adjacently attached to a second set of side walls 150. The first set of side walls 130 comprise a pair of solar panel arrays 135 that are adapted to provide a charging energy that is collected, stored, and then transferred to the remote control 220. The upper surface 120 comprises a curved cradle surface 140 that is adapted to receive the remote control 220 therein, whereby the curvature that is configured to match the underside of a complimentary remote control provided with the base 100.

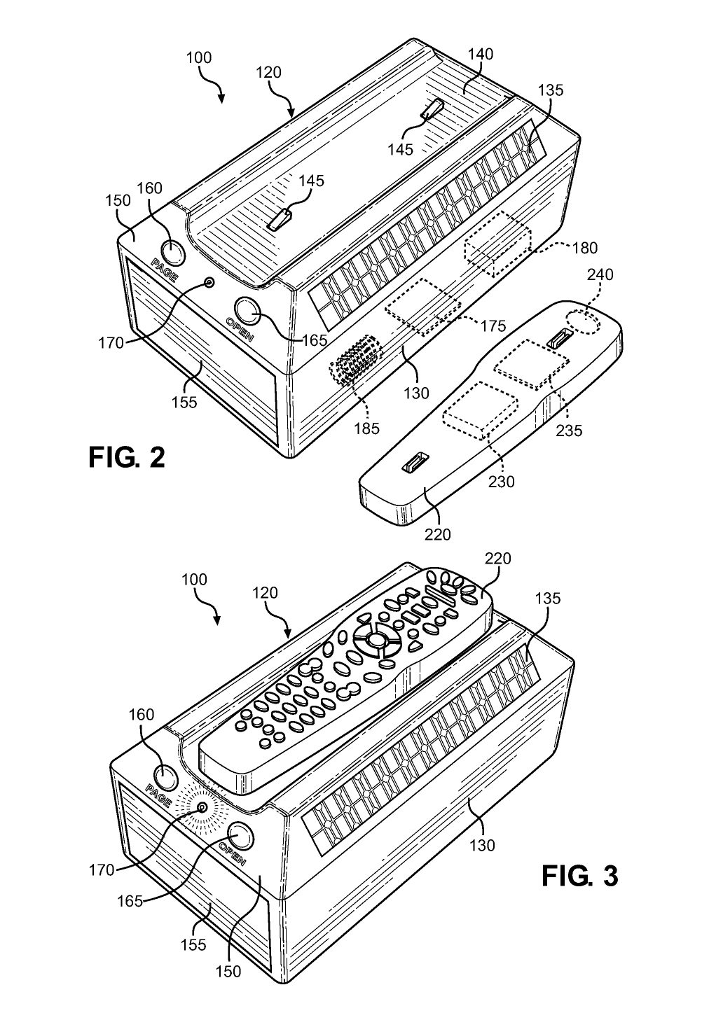

Referring now to FIGS. 1 and 2, the upper surface 120 of the base further comprises a pair of charging prongs 145. A control circuit 180 within the charging base 100 includes a charge controller for the solar panel arrays and a transmitter/receiver. The control circuit 180 is adapted to regulate the voltage generated from a pair of solar panels 135 and transferred to a rechargeable battery 175 within the base 100, and which controls the overall voltage of the rechargeable battery 175 to prevent overcharging, overheating, or the like. The control circuit 180 regulates and directs the transmission of solar powered energy from the solar panels 135 to a rechargeable battery 175 that is adapted to transfer the energy stored therein to the remote control charging prongs 145 on the surface of the base 100. The remote control 220 comprises a pair of corresponding prongs 225 that are positioned to align with the charging prongs 145 of the curved surface 140 of the base 100. Placement of the remote control 220 on the curved surface 140 facilitates the alignment of the prongs, thereby facilitating the flow of electrical power to the battery 235 of the remote control 220 from the battery of the base. The control circuit 180 is further configured to regulate the voltage delivered, the rate of discharge, and may further be adapted to terminate the transmission of energy when a battery 235 within the remote control 220 is fully charged.

The wireless transmitter/receiver of the control circuit 180 is adapted to facilitate wireless communication between the controller base 100 and the remote control 220 when the two devices are not in contact. The remote control 220 comprises a control circuit 230, a rechargeable battery 235, and a wireless receiver/transmitter 240 that is adapted to communicate with the receiver/transmitter of the charging base 100 by sending and receiving wireless signals (preferably RF signals or the like) to the receiver/transmitter of the control circuit 180 of the base 100. The circuit 230 of the remote control 220 is adapted to communicate with the base 100 when the rechargeable battery 235 is fully charged, when the battery 235 is drained, and can receive location identification signals in order to assist an individual attempting to locate the remote control 220.

As shown in FIG. 3, the charging base 100 comprises a light 170 that is configured to illuminate when the remote control 220 is placed on the curved surface 145. The illumination serves as a notification that the remote 220 is properly placed on the charging base 100. Additionally, the illumination of the light source 170 serves as an indicator that the remote control 220 is currently charging. The control circuit 180 is configured to terminate the transfer of energy to the battery 235 when the battery has charged to capacity. Thereafter, the light may turn off, dim, or a different color may illuminate to indicate a remote control charging status to a user.

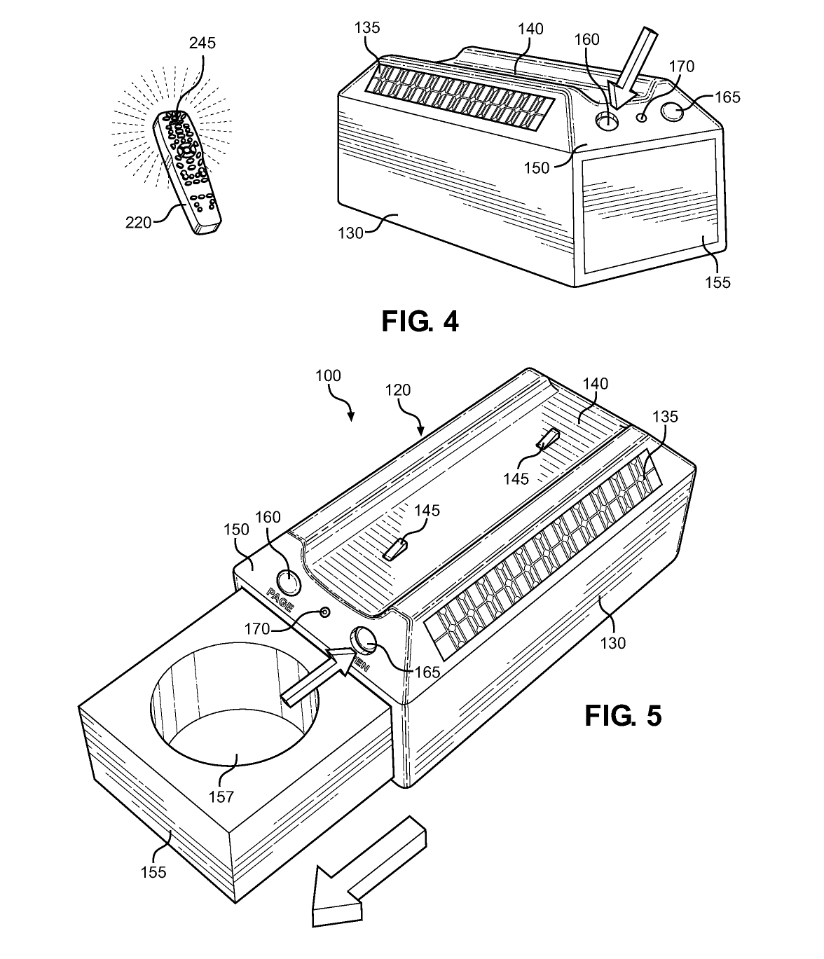

Referring now to FIG. 4, there is displayed a view of the charging base 100 with a depressed button. One of the second set of side walls 150 comprise a pair of first 160 and second 165 actuatable buttons. The first button 160 is configured to instruct the control circuit (See 180, FIG. 2) to transmit a wireless signal to the remote control 220. If the remote control 220 is within a predetermined proximity of the charging base 100, the signal is transmitted to a receiver 240 within the remote control 220. The receiver 240 then activates an audible and/or visual alarm 245 that is adapted to notify a user to the location of the remote control 220. The first actuatable button 160 can comprise indicia or wording that identifies the button as a means for alerting a user to the location of a lost remote control.

As shown in FIG. 5, the second actuatable button 170 is configured to provide a means for projecting a section 155 of the second side wall 150 from the charging base 100. A spring (See 185, FIG. 2) or other extendable mechanism is located within the charging base 100, whereby a depression of the second button 170 actuates the opening of a cup holder 155. The projected cup holder 155 comprises a cylindrical cavity 157 therein that is adapted for the reception of a standard sized cup, thereby providing a means for supporting a drinking container and reducing the likelihood of spill drinks. Moreover, the cylindrical cavity may provide a means for holding other objects therein, such as currency, candy, or other similarly sized objects.

The present invention provides a charging base that is adapted for supplying a charging power to a remote control, whereby a single charging base may be adapted to provide energy to one or more designated remote controllers. The charger 100 comprises a pair of lengthwise sidewalls 130, a pair of widthwise side walls 150, and a curved upper surface 140 that is adapted to receive a remote control 220 thereon. The lengthwise sidewalls 130 each comprise a solar panel 135 that is adapted to supply a charging energy to a pair of prongs 145 on the curved surface of the remote control charging base 100. The remote control 220 comprises a corresponding pair of prongs 225 that are positioned to align with the prongs of the charging base 100. Placement of the remote control 220 on the surface of the charging base facilitates the transfer of energy from the prongs 145 of the base to the prongs 225 of the remote control 220. A user can program to activate the alarm 245 of one or more associated remote controllers, thereby alerting a user to the location of the remote controls.

The widthwise walls 150 comprise a pair of buttons, that when depressed, facilitate a response in the remote control or the charging base. The first button 160 is adapted to inform a user of the location of the remote control 220. Depression of the first button instructs the control circuit of the base to transmit a signal to the remote control. Once the remote control receives the signal, an audible or visual indicator is actuated, thereby assisting a user in finding the location of the remote control after tracking the response from the remote control.

The second button 165 is utilized to eject a section of the widthwise wall. The ejected wall 155 comprises a cylindrical opening 157 that is sized to receive a cup or similarly shaped item therein, which may prevent the spilling of liquids. Moreover, the cylindrical opening 157 may utilized for holding a variety of items therein when opened or closed, thereby providing a container for keys, coins, candies, etc.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A rechargeable remote control cradle assembly, comprising;
a charging base and a remote control;
said charging base comprising a first set of side walls, a second set of side walls, an upper surface, a first control circuit, and a rechargeable battery;
said upper surface comprising a pair of charging prongs thereon;
said first set of side walls further comprising at least one solar panel array;
whereby said first control circuit is adapted to transfer electrical energy from said solar panel array to said rechargeable battery, and thereafter to said prongs;
and said charging base further comprising a retractable cup holder; whereby said holder is located within one of said second side walls
said first control circuit of said charging base comprising a base receiver and transmitter that is adapted to communicate with said remote control;
said remote control comprising a second control circuit, a remote control receiver and transmitter, a rechargeable battery, and at least one remote control charging prong;
whereby said base receiver and transmitter is adapted to communicate with said remote control receiver and transmitter.

2. The remote control cradle assembly of claim 1, wherein said remote control charging prongs are adapted to align with said charging prongs of said charging base.

3. The remote control cradle assembly of claim 1, whereby said control circuit of said charging base is adapted to recharge said remote control battery when said remote control prongs are aligned with said charging base prongs.

4. The remote control cradle assembly of claim 1, wherein said charging base comprises a light that is adapted to indicate a charging of said remote control.

5. The remote control cradle assembly of claim 4, wherein said light is adapted to change degree of illumination or color based on the status of the charging.

6. The remote control cradle assembly of claim 1, wherein said charging base further comprises a first button and a second button.

7. The remote control cradle assembly of claim 6, wherein said first button is adapted to project a section of said second side wall outward from said cradle, whereby said projected section comprises an opening that is adapted to receive a cup therein.

8. The remote control cradle assembly of claim 6, wherein said second button facilitates the transmission of a signal to said remote control, whereby said signal facilitates the actuation of an alarm on said remote control, which is adapted to assist a user in finding a missing remote control.
